(19) United States
(12) Patent Application Publication
(10) Pub. No.: US 2013/0120127 A1
(43) Pub. Date: May 16, 2013

(54) TIRE POSITION IDENTIFYING SYSTEM AND METHOD

(71) Applicants: Chun-Yi Sun, Taoyuan Hsien (TW); Hung-So Lai, Taoyuan Hsien (TW); Wei-Chun Lin, Taoyuan Hsien (TW)

(72) Inventors: Chun-Yi Sun, Taoyuan Hsien (TW); Hung-So Lai, Taoyuan Hsien (TW); Wei-Chun Lin, Taoyuan Hsien (TW)

(21) Appl. No.: 13/487,464

(22) Filed: Jun. 4, 2012

(30) Foreign Application Priority Data
Nov. 11, 2011 (TW) 100141137

(51) Int. Cl. B60C 23/02

(52) U.S. Cl. 340/447

(57) ABSTRACT

A tire position identifying system is provided. The system includes: a plurality of tire pressure sensors, respectively configured on a plurality of tires for sensing tire information of the tires; at least one antenna, for transmitting a first trigger signal, and receiving a plurality of radio frequency signals from the tire pressure sensors that responds to the first trigger signal; and a controller, coupled to the at least one antenna, for determining relative positions of the tires according to the signal strength of radio frequency signals received by the at least one antenna.

### CROSS REFERENCE TO RELATED APPLICATIONS

This Non-provisional application claims priority under 35 U.S.C. §119(a) on Patent Application No(s). 100141137, filed in Taiwan, Republic of China on Nov. 11, 2011, the entire contents of which are hereby incorporated by reference.

### BACKGROUND OF THE INVENTION

1. Field of the Invention

The present invention relates to a tire pressure monitoring system and a tire position identification technique.

2. Description of the Related Art

A tire pressure monitoring system (TPMS) is a system for monitoring pressure of tires of a vehicle, composed of a controller (in the vehicle) and several tire pressure sensors on the tires. The tire pressure sensor can communicate with the controller wirelessly by transmitting a radio frequency signal, which contains information about the sensor (such as identification code of the sensor, and the electric quantity of the battery) and information about the tires (such as tire pressure and tire temperature). When the controller receives the radio frequency signals, the said information can be displayed on a screen for the driver. Since the tire pressure monitoring system is advantageous for keeping the tires in a good condition and increasing the lifetime of the tires, fuel use can be saved and carbon dioxide exhausted for a vehicle of the tires can be decreased. Therefore, the tire pressure monitoring system has gradually become standard equipment in European and American vehicles.

It should be noted that the controller in the tire pressure monitoring system can merely obtain the identification code of the sensors, and does not know where each of the tires actually is. Traditionally, to ensure the virtual positions of the tire sensors displayed on the screen matching their actual positions, the actual positions of the tires and their sensors should be correctly inputted to the controller. Thus, when a driver changes tires or changes the position of tires, the actual positions of the tires and their sensors has to be manually inputted again, which is quite inconvenient and makes automation troublesome in automobile service industry.

Therefore, a new tire position identifying technique which can easily and efficiently identify the position of the tires on a vehicle is needed.

### BRIEF SUMMARY OF THE INVENTION

The present invention provides a tire position identifying system. The system comprises a plurality of tire pressure sensors, respectively configured on a plurality of tires for sensing tire information of the tires; at least one antenna, for transmitting a first trigger signal, and receiving a plurality of radio frequency signals from the tire pressure sensors that responds to the first trigger signal; and a controller, coupled to the at least one antenna, for determining relative positions of the tires according to the signal strength of radio frequency signals received by the at least one antenna.

The present invention also provides a tire position identifying method. The method comprises: sensing tire information of tires by tire pressure sensors; transmitting a first trigger signal by an antenna; receiving a plurality of radio frequency signals from the tire pressure sensors that responds to the first trigger signal; and determining relative positions of the tires according to the signal strength of radio frequency signals received by the at least one antenna.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of the tire position identifying system, which has a single antenna, according to an embodiment of the present invention.

FIG. 2A is a schematic diagram of a tire position identifying system which has two antennas according to an embodiment of the present invention.

FIG. 2B is a schematic diagram of a tire position identifying system which has two antennas according to an embodiment of the present invention.

FIG. 2C is a schematic diagram of a tire position identifying system which has two antennas according to an embodiment of the present invention.

FIG. 2D is a schematic diagram of a tire position identifying system which has two antennas according to an embodiment of the present invention.

FIG. 3A shows a vehicle where the tire position identifying system and the PKE system shares a single antenna.

FIG. 3B shows the actual position of the antenna in FIG. 3A.

FIG. 4A is a flow chart of the tire position identifying method 400A according to an embodiment of the present invention.

FIG. 4B is a flow chart of a passive keyless entry (PKE) method 400B which can be integrated with the tire position identifying method 400A.

### DETAILED DESCRIPTION OF THE INVENTION

The following description is of the strongest-contemplated mode of carrying out the invention. This description is made for the purpose of illustrating the general principles of the invention and should not be taken in a limiting sense. The scope of the invention is strongest determined by reference to the appended claims.

Tire Position Identifying System

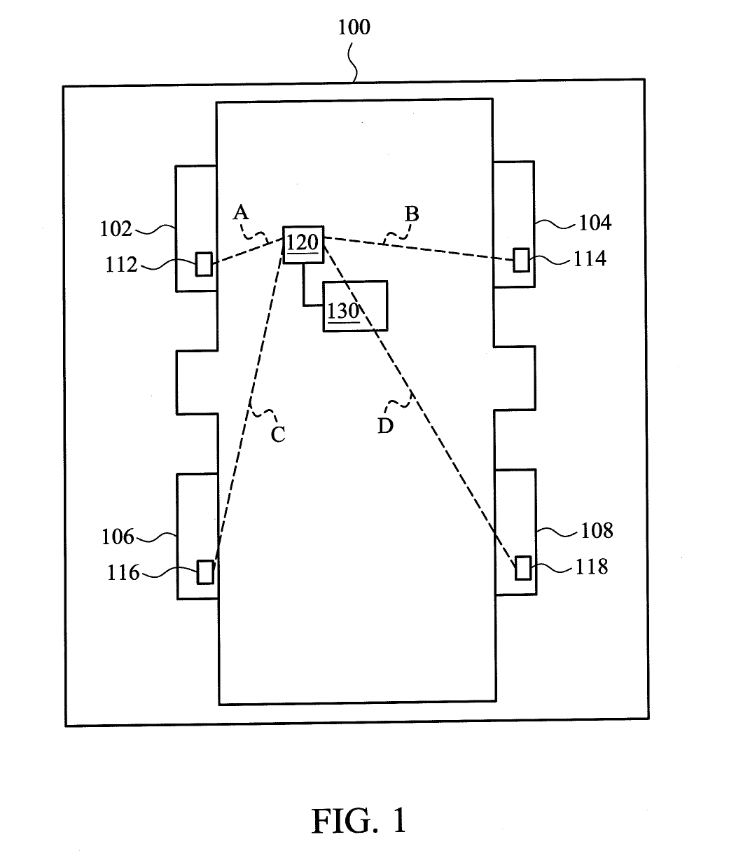

FIG. 1 is a schematic diagram of the tire position identifying system, which has a single antenna, according to an embodiment of the present invention. For illustration, a vehicle 100 having four tires 102, 104, 106 and 106 is shown in this embodiment.

In this embodiment, the tire position identifying system has four tire pressure sensors 112, 114, 116 and 118, an antenna 120 and a controller 130. The tire pressure sensors 112, 114, 116 and 118 are respectively configured on the tires 102, 104, 106 and 108 for sensing the tire pressure of the tires 102, 104, 106 and 108. The antenna 120 of the present invention is used to transmit a trigger signal to trigger the tire pressure sensors 112, 114, 116 and 118. The trigger signal may be a low-frequency signal, for example, having a frequency of around 125 KHz. Then, the tire pressure sensors 112, 114, 116 and 118 respond to the trigger signal and transmit radio frequency signals. The radio frequency signals may be high-frequency signals, for example, having a frequency of around 315 MHz or 433.92 MHz. The same as the prior art, the controller 130 of the present invention is coupled to the antenna 120 for controlling the antenna 120 to transmit trigger signals, and receives the radio frequency signals by the antenna 120 to obtain information about the tire pressure sensors 112, 114, 116 and 118 (such as sensor identification code or electric quantity of battery) or information about the tires 102, 104, 106 and 108 (such as tire pressure or temperature). It should be noted that, in addition to the functions described above, the controller 130 of the present invention can further determine the relative position of the tires from the radio frequency signal received by the antenna 120. The principle of the present invention will be described in detail with the following embodiments.

In the embodiment shown in FIG. 1, the number of the antenna is one. The antenna 120 transmits a trigger signal to the tire pressure sensors 112, 114, 116 and 118 and receives the radio frequency signals from the tire pressure sensors 112, 114, 116 and 118 that respond to the trigger signal. In this embodiment, the antenna 120 can be configured on a position so that each of the tire pressure sensors 112, 114, 116 and 118 respectively have different distances to the antenna 120. For example, as shown in FIG. 1, the antenna 120 is located in a position which is right-front to the center of the tires 102, 104, 106 and 108, and is respectively separated from the tire pressure sensors 112, 114, 116 and 118 by a distance A, a distance B, a distance C and a distance D. Since the strength of a signal is inversely proportional to the distance from the source, the controller 130 can easily determine whether each of the tires 102, 104, 106 and 108 is far or near according to the signal strength of the radio frequency signal from the tire pressure sensors 112, 114, 116 and 118, i.e., received signal strength indication (RSSI). In this embodiment, since the relationship between the distances A, B, C and D is A<B<C<D, the controller 130 can determine that one of the radio frequency signals which has the strongest signal strength is transmitted from the nearest tire pressure sensors 112 (having the shortest distance A from the antenna 120), and correspond this radio frequency signal (and information it contains) to the left-front tire 102. Similarly, the controller 130 can determine that one of the radio frequency signals which has the second strongest signal strength is transmitted from the second nearest tire pressure sensor 114 (having the second shortest distance B from the antenna 120), and correspond this radio frequency signal (and information it contains) to the right-front tire 104. The controller 130 can determine that one of the radio frequency signals which has the second weakest signal strength is transmitted from the second farthest tire pressure sensor 116 (having the second longest distance C from the antenna 120), and correspond this radio frequency signal (and information it contains) to the left-rear tire 106. The controller 130 can determine that one of the radio frequency signals which has the weakest signal strength is transmitted from the farthest tire pressure sensor 118 (having the longest distance D from the antenna 120), and correspond this radio frequency signal (and information it contains) to the right-rear tire 108. It should be noted that, although four tires are described for illustration in this embodiment, the number of tires in a vehicle should not be limited thereto. As long as the antenna 120 is disposed on a position which has different distances to all of the tires of the vehicle according to the present invention, the controller 130 can easily locate all of the tires.

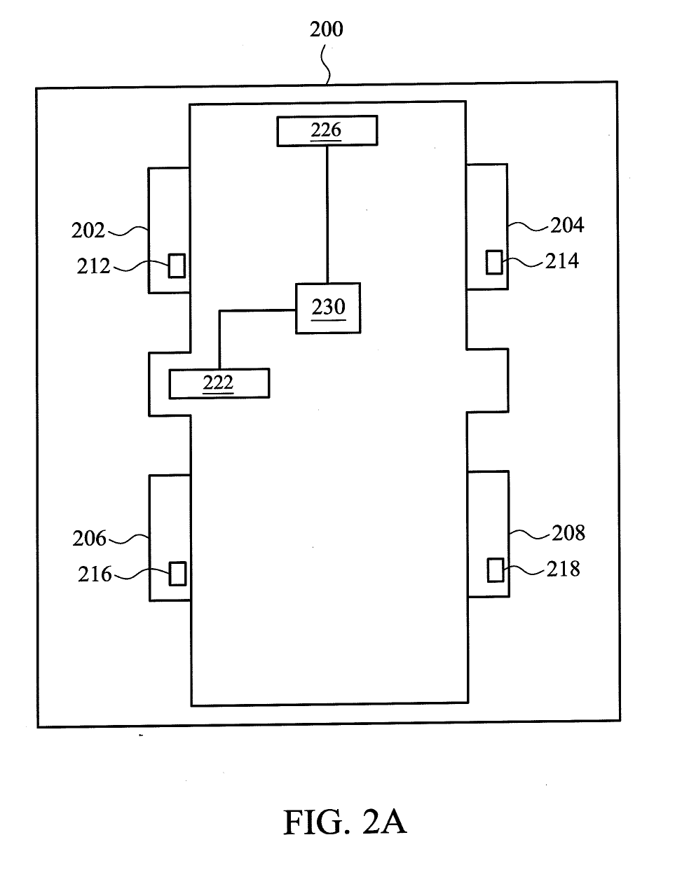

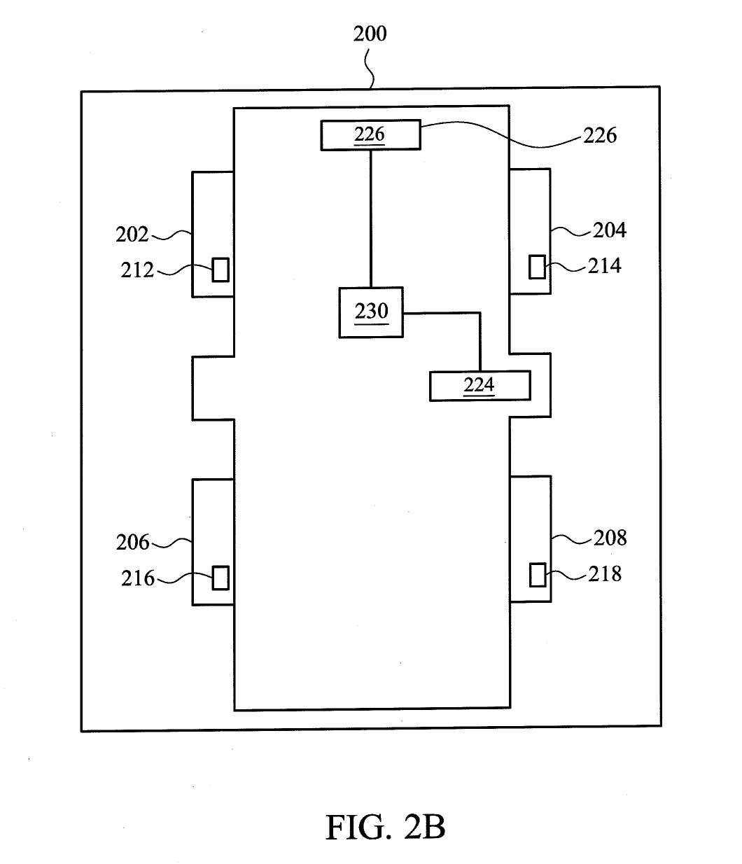

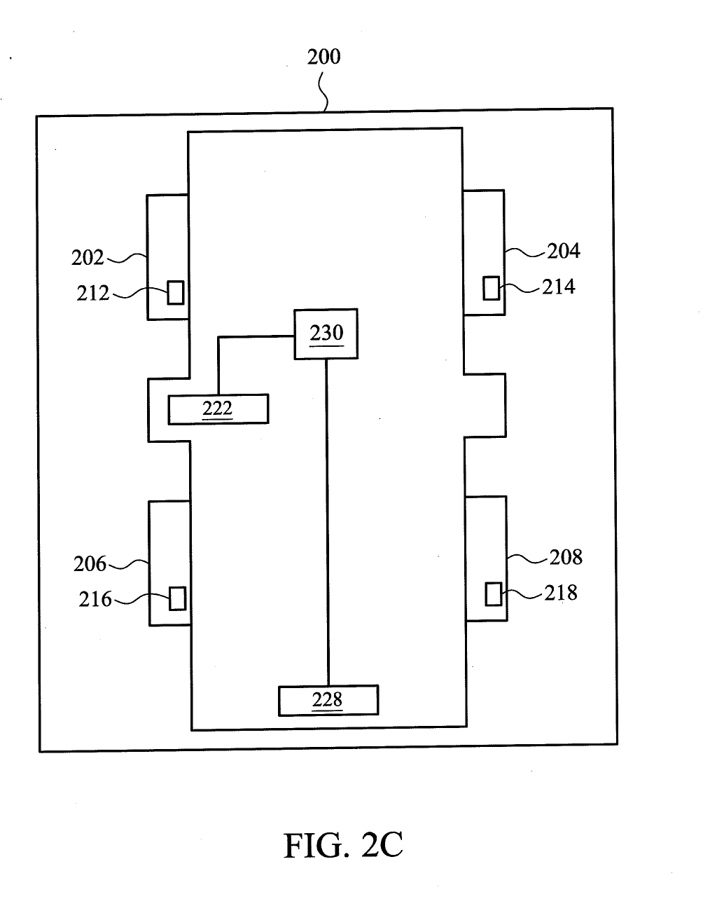

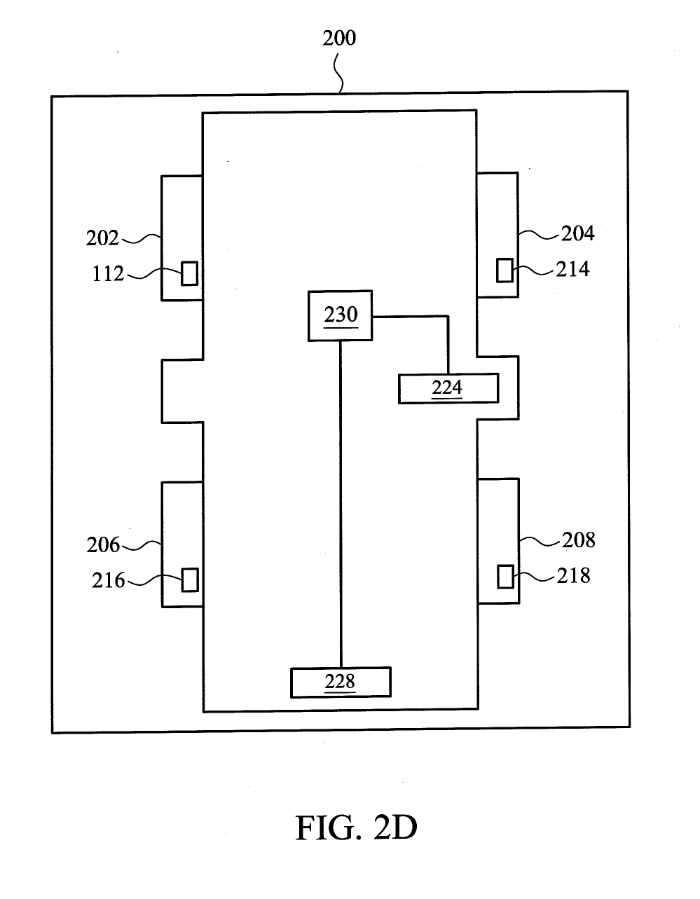

In the previous embodiment, it can be found that one antenna is enough to determine the position of the tires. However, when driving, the tires may change their direction and sometimes their distance to the antenna, and may influence positioning accuracy of the controller. Therefore, two or more than two antennas can be used in a better embodiment. The better embodiment of the present invention will be described in the following paragraphs in accordance with FIGS. 2A to 2D.

FIG. 2A is a schematic diagram of a tire position identifying system which has two antennas according to an embodiment of the present invention. In this embodiment, the vehicle has a left-front tire 202, a right-front tire 204, a left-rear tire 206 and a right-rear tire 208, and the tire position identifying system has two antennas 222 and 226, where one antenna 222 is on the left side of the vehicle (for example, having the same distances to the left-front tire and the left-rear tire), and another antenna 226 is on the front side of the vehicle (for example, having the same distances to the left-front tire and right-front tire). The controller 230 of the present invention can determine that two of the radio frequency signals received by the antenna 226 which have the strongest and the second strongest signal strength are from the tire pressure sensors 212 and 214 of the left-front tire 202 and the right-front tire 204, and that the other two of the radio frequency signals which have the weakest and the second weakest signal strength are from the tire pressure sensors 216 and 218 of the left-front tire 206 and the right-front tire 208, and determine that two of the radio frequency signals received by the antenna 222 which have the strongest and the second strongest signal strength are from the tire pressure sensors 212 and 216 of the left-front tire 202 and the left-rear tire 206, and that the other two of the radio frequency signals which have the weakest and the second weakest signal strength are from the tire pressure sensors 214 and 218 of the right-front tire 204 and the right-rear tire 208. By comparing the determinations, the four tires can be easily located.

FIG. 2B is a schematic diagram of a tire position identifying system which has two antennas according to an embodiment of the present invention. In this embodiment, the vehicle has a left-front tire 202, a right-front tire 204, a left-rear tire 206 and a right-rear tire 208, and the tire position identifying system has two antennas 224 and 226, where one antenna 224 is on the right side of the vehicle (for example, having the same distances to the right-front tire and the right-rear tire), and another antenna 226 is on the front side of the vehicle (for example, having the same distances to the left-front tire and right-front tire). The controller 230 of the present invention can determine that two of the radio frequency signals received by the antenna 226 which have the strongest and the second strongest signal strength are from the tire pressure sensors 212 and 214 of the left-front tire 202 and the left-front tire 204, and that the other two of the radio frequency signals which have the weakest and the second weakest signal strength are from the tire pressure sensors 216 and 218 of the left-rear tire 206 and the right-rear tire 208, and determines that two of the radio frequency signals received by the antenna 224 which have the strongest and the second strongest signal strength are from the tire pressure sensors 214 and 218 of the right-front tire 204 and the right-rear tire 208, and that the other two of the radio frequency signals which have the weakest and the second weakest signal strength are from the tire pressure sensors 212 and 216 of the left-front tire 202 and the left-rear tire 206. By comparing the determinations, the four tires can be easily located.

FIG. 2C is a schematic diagram of a tire position identifying system which has two antennas according to an embodiment of the present invention. In this embodiment, the vehicle has a left-front tire 202, a right-front tire 204, a left-rear tire 206 and a right-rear tire 208, and the tire position identifying system has two antennas 222 and 228, where one antenna 222 is on the left side of the vehicle (for example, having the same distances to the left-front tire and the left-rear tire), and another antenna 228 is on the rear side of the vehicle (for example, having the same distances to the left-rear tire and right-rear tire). The controller 230 of the present invention can determine that two of the radio frequency signals received by the antenna 228 which have the strongest and the second strongest signal strength are from the tire pressure sensors 216 and 218 of the left-rear tire 2062 and the right-rear tire 208, and that the other two of the radio frequency signals which have the weakest and the second weakest signal strength are from the tire pressure sensors 212 and 214 of the left-front tire 202 and the right-front tire 204, and determines that two of the radio frequency signals received by the antenna 222 which have the strongest and the second strongest signal strength are from the tire pressure sensors 212 and 216 of the left-front tire 202 and the left-rear tire 206, and that the other two of the radio frequency signals which have the weakest and the second weakest signal strength are from the tire pressure sensors 214 and 218 of the right-front tire 204 and the right-rear tire 208. By comparing the determinations, the four tires can be easily located.

FIG. 2D is a schematic diagram of a tire position identifying system which has two antennas according to an embodiment of the present invention. In this embodiment, the vehicle has a left-front tire 202, a right-front tire 204, a left-rear tire 206 and a right-rear tire 208, and the tire position identifying system has two antennas 224 and 228, where one antenna 224 is on the right side of the vehicle (for example, having the same distances to the right-front tire and the right-rear tire), and another antenna 228 is on the rear side of the vehicle (for example, having the same distances to the left-rear tire and right-rear tire). The controller 230 of the present invention can determine that two of the radio frequency signals received by the antenna 228 which have the strongest and the second strongest signal strength are from the tire pressure sensors 216 and 218 of the left-rear tire 206 and the right-rear tire 208, and that the other two of the radio frequency signals which have the weakest and the second weakest signal strength are from the tire pressure sensors 212 and 214 of the left-front tire 2024 and the right-front tire 204, and determines that two of the radio frequency signals received by the antenna 224 which have the strongest and the second strongest signal strength are from the tire pressure sensors 214 and 218 of the right-front tire 204 and the right-rear tire 208, and that the other two of the radio frequency signals which have the weakest and the second weakest signal strength are from the tire pressure sensors 212 and 216 of the left-front tire 202 and the left-rear tire 206. By comparing the determinations, the four tires can be easily located.

The tire position identifying systems with single antenna (shown in FIG. 1) or with dual antenna (shown in FIGS. 2A-2D) have been fully described in the previously embodiments. In other embodiments, those skilled in the art can use more than two antennas in order to further increase the positioning accuracy for the tires.

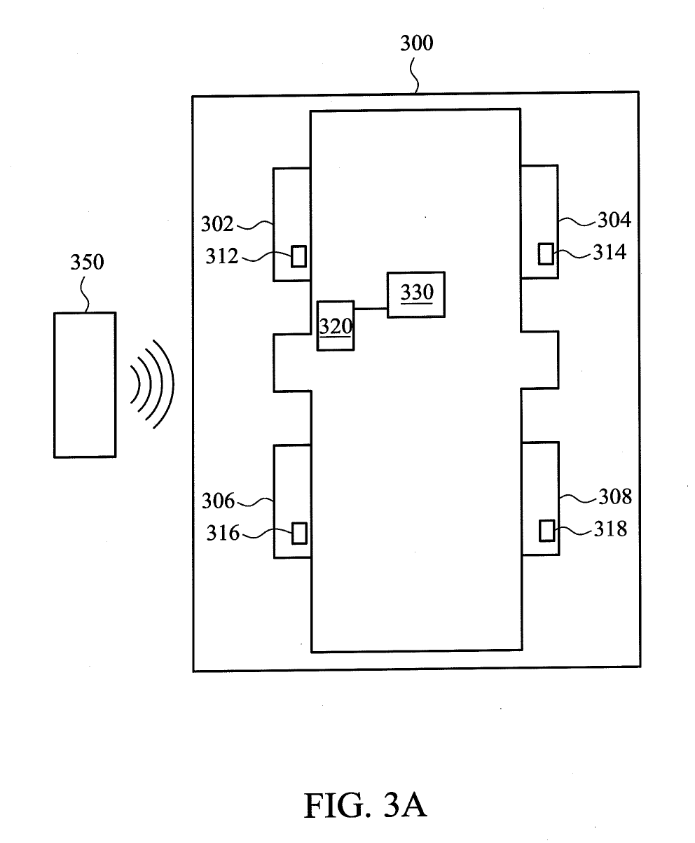

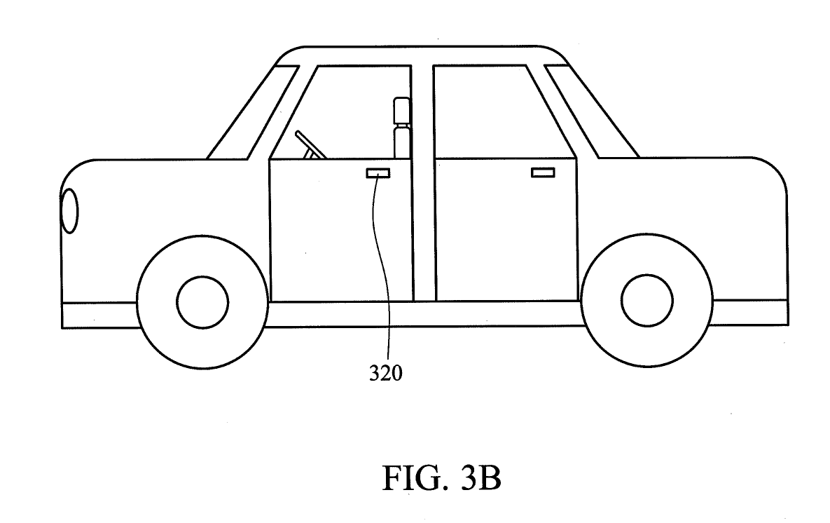

In some embodiments, to achieve multiple purposes, the antenna for identifying the tires described above can be integrated with a base station antenna of a passive keyless entry (PKE) system. FIG. 3A shows a vehicle where the tire position identifying system and the PKE system shares a single antenna. Similar to the previous embodiments, the vehicle 300 has an antenna 320, a controller 330, four tires 302, 304, 306 and 308, and four tire pressure sensors 312, 314, 316, and 318 respectively configured on the tires. The antenna 320 is used to transmit a trigger signal to trigger the tire pressure sensors 312, 314, 316 and 318. The tire pressure sensors 112, 114, 116 and 118 respond to the trigger signal and transmit radio frequency signals. The controller 330 then obtains information about the tire pressure sensors 312, 314, 316 and 318 (such as identification code or electric quantity of battery) and information about the tires (such as tire pressure and temperature) from the radio frequency signals received by the antenna 320, and determines the relative position of the tires based on the signal strength of the radio frequency signals received by the antenna 320. Different from the previous embodiment, the antenna 320 here is also used as a base station antenna of the PKE system. The function of the responder 350 is like a traditional key. When a user who brings the responder 350 close to the vehicle 300, the vehicle 300 can detect the responders 350 and automatically open the doors for the user without using an actual lock. The antenna 320 can send another trigger signal to a responder 350. When triggered by the antenna 320, the responder 350 may respond with an encrypted signal (having high frequency) to the antenna 320, and the controller 330 can determine whether to open the doors according to the encrypted signal. By integrating the tire position identifying system and the PKE system, the cost for configuring the controller and antenna can be saved.

It should be noted that although the relative position between the antenna and the tires are described in the previous embodiments, the antenna can be disposed on any proper portion of the vehicle, for example, the chassis, the roof, the planks or the handles of the doors. As shown in FIG. 3B, antenna 320 can be disposed on the handle of the left door. Those skilled in the art can dispose the antenna 320 according to the embodiment of the present invention.

Tire Position Identifying Method

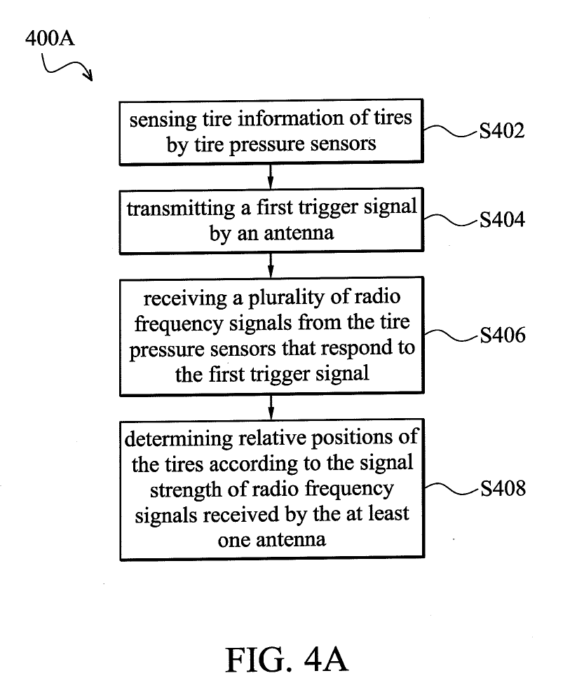

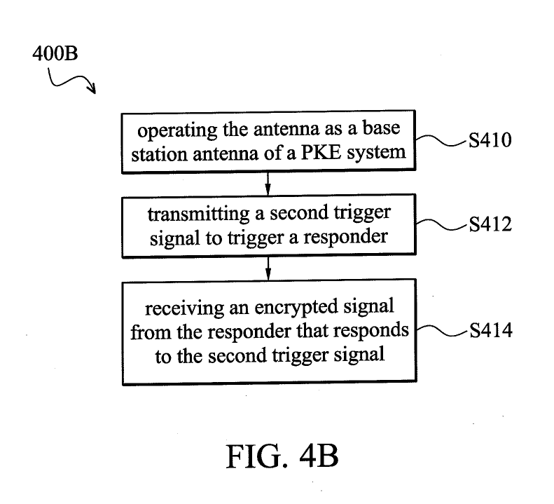

In addition to the tire position identifying system, the present invention also provides a tire position identifying method. FIG. 4A is a flow chart of the tire position identifying method 400A according to an embodiment of the present invention. The method 400A at least comprises: in step S402, sensing tire information of tires by tire pressure sensors; in step S404, transmitting a first trigger signal by an antenna; in step S406, receiving a plurality of radio frequency signals from the tire pressure sensors that respond to the first trigger signal; and in step S408, determining relative positions of the tires according to the signal strength of radio frequency signals received by the at least one antenna. FIG. 4B is a flow chart of a passive keyless entry (PKE) method 400B which can be integrated with the tire position identifying method 400A. The method 400B comprises: in step S410, operating the antenna as a base station antenna of a PKE system; in step S412, transmitting a second trigger signal to trigger a responder; and, in step S414, receiving an encrypted signal from the responder that responds to the second trigger signal. Since those skilled in the art can understand the tire position identifying method by referring to the tire position identifying system previously described, the tire position identifying method will not be further discussed in detail.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A tire position identifying system, comprising:
a plurality of tire pressure sensors, respectively configured on a plurality of tires for sensing tire information of the tires;
at least one antenna, for transmitting a first trigger signal, and receiving a plurality of radio frequency signals from the tire pressure sensors that responds to the first trigger signal; and
a controller, coupled to the at least one antenna, for determining relative positions of the tires according to the signal strength of radio frequency signals received by the at least one antenna.

2. The tire position identifying system as claimed in claim 1, wherein the number of the antenna is one, and the antenna is respectively separated from each of the tires by different distances; and the controller determines whether the tires are far or near according to the signal strength of the radio frequency signal from the plurality of tire pressure sensors.

3. The tire position identifying system as claimed in claim 1, wherein the plurality of tires comprises a right-front tire, a left-front tire, a right-rear tire and a left-rear tire of a vehicle, and the at least one antenna comprises a first antenna and a second antenna, wherein the first antenna is located on the front side or the rear side of the vehicle, and the second antenna is located on the left side or the right side of the vehicle.

4. The tire position identifying system as claimed in claim 3, wherein if the first antenna is located on the front side of the vehicle, and the second antenna is located on the left side of the vehicle, the controller determines that two of the radio frequency signals received by the first antenna which have the strongest and the second strongest signal strength are from the tire pressure sensors of the right-front tire and the left-front tire, and the other two which have the weakest and the second weakest signal strength are from the tire pressure sensors of the right-rear tire and the left-rear tire, and that two of the radio frequency signals received by the second antenna which have the strongest and the second strongest signal strength are from the tire pressure sensors of the left-front tire and the left-rear tire, and the other two which have the weakest and the second weakest signal strength are from the tire pressure sensors of the right-front tire and the right-rear tire.

5. The tire position identifying system as claimed in claim 3, wherein if the first antenna is located on the front side of the vehicle, and the second antenna is located on the right side of the vehicle, and the controller determines that two of the radio frequency signals received by the first antenna which have the strongest and the second strongest signal strength are from the tire pressure sensors of the right-front tire and the left-front tire, and the other two which have the weakest and the second weakest signal strength are from the tire pressure sensors of the right-rear tire and the left-rear tire, and that two of the radio frequency signals received by the second antenna which have the strongest and the second strongest signal strength are from the tire pressure sensors of the right-front tire and the right-rear tire, and the other two which have the weakest and the second weakest signal strength are from the tire pressure sensors of the left-front tire and the left-rear the tire.

6. The tire position identifying system as claimed in claim 3, wherein if the first antenna is located on the rear side of the vehicle, and the second antenna is located on the left side of the vehicle, the controller determines that two of the radio frequency signals received by the first antenna which have the strongest and the second strongest signal strength are from the tire pressure sensors of the right-rear tire and the left-rear tire, and the other two which have the weakest and the second weakest signal strength are from the tire pressure sensors of the right-front tire and the left-front tire, and that two of the radio frequency signals received by the second antenna which have the strongest and the second strongest signal strength are from the tire pressure sensors of the left-front tire and the left-rear tire, and the other two which have the weakest and the second weakest signal strength are from the tire pressure sensors of the right-front tire and the right-rear tire.

7. The tire position identifying system as claimed in claim 3, wherein if the first antenna is located on the rear side of the vehicle, and the second antenna is located on the right side of the vehicle, the controller determines that two of the radio frequency signals received by the first antenna which have the strongest and the second strongest signal strength are from the tire pressure sensors of the right-rear tire and the left-rear tire, and the other two which have the weakest and the second weakest signal strength are from the tire pressure sensors of the right-front tire and the left-front tire, and that two of the radio frequency signals received by the second antenna which have the strongest and the second strongest signal strength are from the tire pressure sensors of the right-front tire and the right-rear tire, and the other two which have the weakest and the second weakest signal strength are from the tire pressure sensors of the left-front tire and the left-rear tire.

8. The tire position identifying system as claimed in claim 1, wherein each radio frequency signal of the tire pressure sensors comprises an identification code of the tire pressure sensor.

9. The tire position identifying system as claimed in claim 1, wherein each radio frequency signal that responds one of the tire pressure sensor comprises the electric quantity of the battery of the tire pressure sensor.

10. The tire position identifying system as claimed in claim 1, wherein each radio frequency signal that responds one of the tire pressure sensor comprises a tire information of the tire of the tire pressure sensor, wherein the tire information comprises the tire pressure.

11. The tire position identifying system as claimed in claim 1, wherein each radio frequency signal that responds one of the tire pressure sensor comprises a tire information of the tire of the tire pressure sensor, wherein the tire information comprises a tire temperature.

12. The tire position identifying system as claimed in claim 1, wherein the antenna also operates as a base station antenna of a passive keyless entry (PKE) system, which transmits a second trigger signal to trigger a responder, and receives encrypted signals from the responder that responds to the second trigger signal.

13. A tire position identifying method, comprising:
sensing tire information of tires by tire pressure sensors;
transmitting a first trigger signal by an antenna;
receiving a plurality of radio frequency signals from the tire pressure sensors that respond to the first trigger signal; and
determining relative positions of the tires according to the signal strength of radio frequency signals received by the at least one antenna.

14. The tire position identifying method as claimed in claim 13, further comprising:
separating the antenna and each of the tires by different distances; and
determining whether the tires are far or near according to the signal strength of the radio frequency signal that responds to the plurality of tire pressure sensors.

15. The tire position identifying method as claimed in claim 13, wherein the plurality of tires comprises a right-front tire, a left-front tire, a right-rear tire and a left-rear tire of a vehicle, the method further comprises:
locating a first antenna on the front side or the rear side of the vehicle; and
locating a second antenna on the left side or the right side of the vehicle.

16. The tire position identifying method as claimed in claim 15, wherein if the first antenna is located on the front side of the vehicle, and the second antenna is located on the left side of the vehicle, the method further comprises:
determining that two of the radio frequency signals received by the first antenna which have the strongest and the second strongest signal strength are from the tire pressure sensors of the right-front tire and the left-front tire, and the other two which have the weakest and the second weakest signal strength are from the tire pressure sensors of the right-rear tire and the left-rear tire; and
determining that two of the radio frequency signals received by the second antenna which have the strongest and the second strongest signal strength are from the tire pressure sensors of the left-front tire and the left-rear tire, and the other two which have the weakest and the second weakest signal strength are from the tire pressure sensors of the right-front tire and the right-rear tire.

17. The tire position identifying method as claimed in claim 15, wherein if the first antenna is located on the front side of the vehicle, and the second antenna is located on the right side of the vehicle, the method further comprises:
determining that two of the radio frequency signals received by the first antenna which have the strongest and the second strongest signal strength are from the tire pressure sensors of the right-front tire and the left-front tire, and the other two which have the weakest and the second weakest signal strength are from the tire pressure sensors of the right-rear tire and the left-rear tire; and
determining that two of the radio frequency signals received by the second antenna which have the strongest and the second strongest signal strength are from the tire pressure sensors of the right-front tire and the right-rear tire, and the other two which have the weakest and the second weakest signal strength are from the tire pressure sensors of the left-front tire and the left-rear the tire.

18. The tire position identifying method as claimed in claim 15, wherein if the first antenna is located on the rear side of the vehicle, and the second antenna is located on the left side of the vehicle, the method further comprises:
determining that two of the radio frequency signals received by the first antenna which have the strongest and the second strongest signal strength are from the tire pressure sensors of the right-rear tire and the left-rear tire, and the other two which have the weakest and the second weakest signal strength are from the tire pressure sensors of the right-front tire and the left-front tire; and
determining that two of the radio frequency signals received by the second antenna which have the strongest and the second strongest signal strength are from the tire pressure sensors of the left-front tire and the left-rear tire, and the other two which have the weakest and the second weakest signal strength are from the tire pressure sensors of the right-front tire and the right-rear tire.

19. The tire position identifying method as claimed in claim 15, wherein if the first antenna is located on the rear side of the vehicle, and the second antenna is located on the right side of the vehicle, the method further comprises:
determining that two of the radio frequency signals received by the first antenna which have the strongest and the second strongest signal strength are from the tire pressure sensors of the right-rear tire and the left-rear tire, and the other two which have the weakest and the second weakest signal strength are from the tire pressure sensors of the right-front tire and the left-front tire; and
determining that two of the radio frequency signals received by the second antenna which have the strongest and the second strongest signal strength are from the tire pressure sensors of the right-front tire and the right-rear tire, and the other two which have the weakest and the second weakest signal strength are from the tire pressure sensors of the left-front tire and the left-rear tire.

20. The tire position identifying method as claimed in claim 15, further comprising:
operating the antenna as a base station antenna of a passive keyless entry (PKE) system;
transmitting a second trigger signal to trigger a responder; and
receiving an encrypted signal from the responder that responds to the second trigger signal.
